(19) United States
(12) Patent Application Publication
(10) Pub. No.: US 2018/0154317 A1
(43) Pub. Date: Jun. 7, 2018

(54) FILTER MEMBRANE

(71) Applicant: IBIDEN CO., LTD., Ogaki (JP)

(72) Inventors: Masatoshi Kunieda, Ogaki (JP); Hirokazu Higashi, Ogaki (JP)

(73) Assignee: IBIDEN CO., LTD., Ogaki (JP)

(21) Appl. No.: 15/831,765

(22) Filed: Dec. 5, 2017

(30) Foreign Application Priority Data
Dec. 6, 2016 (JP) 2016-236997

(51) Int. Cl. B01D 69/12; B01D 69/02; B01D 69/10

(52) U.S. Cl. CPC B01D 69/12; B01D 69/02; B01D 71/48; B01D 2201/0407; B01D 69/10

(57) ABSTRACT

A filter membrane for selectively separating a specific material from other materials in a processing medium includes a membrane including resin material and having openings formed such that the openings selectively separate a specific material from other materials in a processing medium. The membrane has a first surface and a second surface on the opposite side with respect to the first surface such that the first surface receives the processing medium supplied to the membrane, the openings are formed through the membrane such that each of the openings has an opening part extending from the second surface toward the first surface and an expansion part expanding a size of the opening part and extending from the opening part to the first surface, and the first surface of the membrane is divided into multiple regions.

### CROSS-REFERENCE TO RELATED APPLICATIONS

The present application is based upon and claims the benefit of priority to Japanese Patent Application No. 2016-236997, filed Dec. 6, 2016, the entire contents of which are incorporated herein by reference.

### BACKGROUND OF THE INVENTION

### Field of the Invention

The present invention relates to a filter membrane.

### Description of Background Art

Japanese Patent Laid-Open Publication No. 2011-78481 describes filters for removing pollutants from the polluted atmosphere. Japanese Patent Laid-Open Publication No. 2008-86996 describes a filter membrane that includes a polymer filter layer and a polymer support layer. The entire contents of these publications are incorporated herein by reference.

### SUMMARY OF THE INVENTION

According to one aspect of the present invention, a filter membrane includes a membrane including resin material and having openings formed such that the openings selectively separate a specific material from other materials in a processing medium. The membrane has a first surface and a second surface on the opposite side with respect to the first surface such that the first surface receives the processing medium supplied to the membrane, the openings are formed through the membrane such that each of the openings has an opening part extending from the second surface toward the first surface and an expansion part expanding a size of the opening part and extending from the opening part to the first surface, and the first surface of the membrane is divided into multiple regions.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a plan view schematically illustrating a filter membrane according to an embodiment of the present invention;

FIG. 1B is a cross-sectional view along an A-A line of the filter membrane illustrated in FIG. 1A;

FIG. 2 is a cross-sectional view schematically illustrating a shape of a cross section that includes an opening and is perpendicular to the second surface in a filter membrane according to an embodiment of the present invention;

FIG. 3 is a plan view schematically illustrating a filter membrane according to a first embodiment of the present invention;

FIG. 4 is a plan view schematically illustrating a filter membrane according to a second embodiment of the present invention;

FIG. 5 is a plan view schematically illustrating a filter membrane according to a third embodiment of the present invention;

FIG. 6 is a plan view schematically illustrating a filter membrane according to a fourth embodiment of the present invention;

FIG. 7 is a plan view schematically illustrating a filter membrane according to a fifth embodiment of the present invention;

FIG. 8 is a plan view schematically illustrating a filter membrane according to a sixth embodiment of the present invention;

FIG. 9A-9H are cross-sectional views schematically illustrating processes in a method for manufacturing a filter membrane according to an embodiment of the present invention;

FIG. 10A-10F are cross-sectional views schematically illustrating a two-stage master mold fabrication process in a method for manufacturing a filter membrane according to an embodiment of the present invention;

FIG. 11A-11C are cross-sectional views schematically illustrating a one-stage master mold fabrication process in a method for manufacturing a filter membrane according to an embodiment of the present invention; and

FIG. 12A-12F are cross-sectional views schematically illustrating a master mold fabrication process in a method for manufacturing another filter membrane according to an embodiment of the present invention.

### DETAILED DESCRIPTION OF THE EMBODIMENTS

Embodiments will now be described with reference to the accompanying drawings, wherein like reference numerals designate corresponding or identical elements throughout the various drawings.

In a filter membrane according to an embodiment of the present invention, multiple openings are formed, and the openings selectively separate a specific material from other materials in a processing medium. The filter membrane has a first surface, which is on a side where the processing medium is supplied, and a second surface, which is on an opposite side of the first surface. A shape of a cross section that includes one of the openings and is perpendicular to the second surface includes at least an opening part, which is formed from the second surface toward the first surface, and an expansion part, which is formed by expanding a size of the opening part before the opening part reaches the first surface. The first surface is divided into two or more regions. The term “opening” is a word of a high-level concept including the opening part and the expansion part.

A filter membrane according to an embodiment of the present invention can be used as a filter membrane for removing dust, viruses, bacteria and the like present in air or a gas of a specific component and a liquid to obtain clean air, gas, liquid and the like, and, conversely, can also be used as a filter membrane for obtaining, by selectively filtering and separating, only particles, viruses, bacteria, cells and the like of specific sizes present in air or a gas of a specific component and a liquid.

An example of a shape, a structure and the like of a filter membrane according to an embodiment of the present invention is further described in detail.

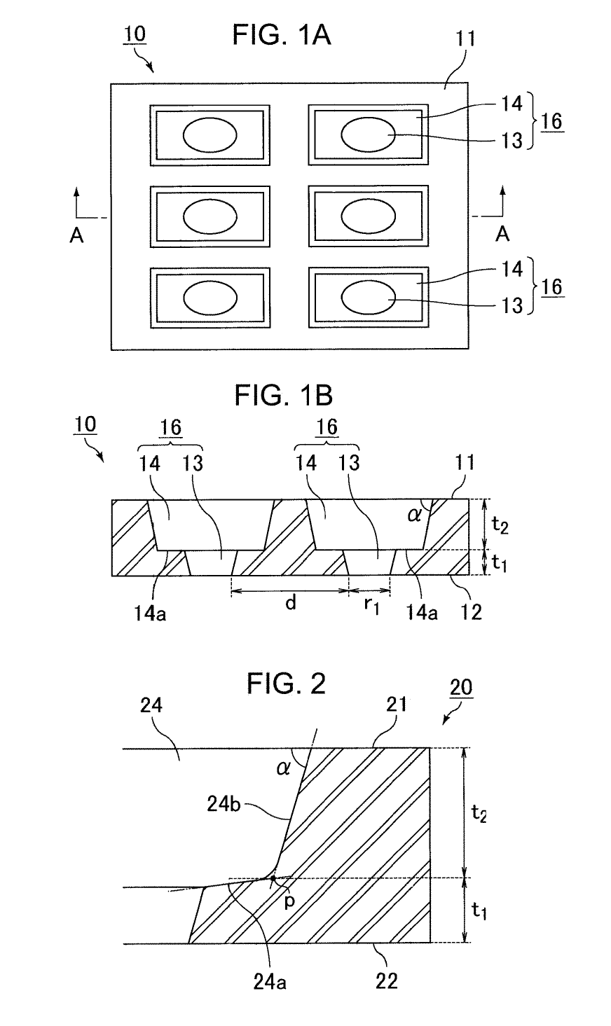

FIG. 1A is a plan view schematically illustrating a filter membrane according to an embodiment of the present invention. FIG. 1B is a cross-sectional view along an A-A line of the filter membrane illustrated in FIG. 1A.

A filter membrane 10 according to an embodiment of the present invention illustrated in FIGS. 1A and 1B has a first surface 11, which is on a side where a processing medium is supplied, and a second surface 12, which is on an opposite side of the first surface. A shape of a cross section that includes one of openings 16 and is perpendicular to the second surface 12 includes at least an opening part 13, which is formed from the second surface 12 toward the first surface 11, and an expansion part 14, which is formed by expanding a size of the opening part 13 before the opening part 13 reaches the first surface 11. The first surface 11 excluding the expansion parts 14 is continuous. As illustrated in FIGS. 1A and 1B, the term “opening 16” is a word of a high-level concept including the opening part 13 and the expansion part 14.

As illustrated in FIGS. 1A and 1B, the filter membrane 10 according to an embodiment of the present invention can be utilized as a filter membrane in which the multiple openings 16 are formed each including an opening part 13 and an expansion part 14 and the openings 16 are used to selectively separate a specific material from other materials in a processing medium.

The openings of a filter membrane according to an embodiment of the present invention can conceptually be divided into two layers including a layer in which the opening parts are formed and a layer in which the expansion parts are formed. However, it is desirable that the filter membrane be entirely formed of the same material and be integrally formed.

When the filter membrane is entirely formed of the same material and is integrally formed, the filter membrane can have more excellent mechanical properties without a risk of causing layer separation as in a case where two layers are adhered to each other, and a disadvantage that occurs in the case where two layers are adhered to each other, that is, variation in pore areas or pore diameters, is unlikely to occur. Therefore, when the filter membrane is used for inspection, experiment or the like, data with good reproducibility can be obtained.

Further, in a filter membrane according to an embodiment of the present invention, the first surface is divided into two or more regions. Therefore, a volume of the expansion parts increases, the opening parts are more unlikely to be blocked by substances not to be filtered, a filtration process can efficiently proceed, and data with good reproducibility can be obtained.

A filter membrane according to an embodiment of the present invention can be utilized as a filter membrane for removing dust, viruses, bacteria and the like present in air or a gas of a specific component and a liquid to obtain clean air, gas, liquid and the like, and, conversely, can also be used as a filter membrane for obtaining, by selectively filtering and separating, only particles, viruses, bacteria, cells and the like of specific sizes present in air or a gas of a specific component and a liquid.

Examples of a resin material that forms a filter membrane according to an embodiment of the present invention include a silicone-based resin, an acrylic resin, a polyimide resin, a phenol resin, a silica hybrid composite, and the like. The above-described resins are highly flexible and thus allow the filter membrane to have excellent mechanical properties and can easily ensure self-reliance of the filter membrane. A method for manufacturing a filter membrane according to an embodiment of the present invention will be described in detail later.

As a resin material for forming a filter membrane according to an embodiment of the present invention, a silicone-based resin, an acrylic resin, a polyimide resin, a phenol resin or the like of a negative type can be used. When these resins are used, by irradiating light such as ultraviolet light, solubility of an irradiated portion with respect to a solvent is increased, and a portion irradiated with light can be dissolved and removed using a liquid developer.

A silicone-based resin is obtained by combining trialkoxysilane and the like with tetrafunctional tetraalkoxysilane as a main component, and a three-dimensional structure of SiO is finally formed in the resin. Further, a silicone-based resin can be cured by using a catalyst, or by heating. In this way, when a silicone-based resin is used as a resin film, the resin film has a three-dimensional structure of SiO and thus is hard and has excellent wear resistance.

An acrylic resin is formed of polyfunctional monomers, monofunctional monomer, and polymers and is obtained by controlling a degree of cross-linking based on types and amounts of polyfunctional monomers. Examples of polyfunctional monomers include polyol acrylate, polyester acrylate, urethane acrylate, epoxy acrylate and the like. In this way, when an acrylic resin is used as a resin film, the resin film has a feature of being able to be cured in a short time by ultraviolet irradiation.

A silica hybrid composite is obtained by combining inorganic particles of silica sol or the like or three-dimensional structures of SiO obtained using the above-described silicone-based resin and an acrylic resin used for forming a hard coat layer or other resins. By combining resins having radically polymerizable acryloyl group (AC) and methacryloyl group (MAC), or a cationically polymerizable oxetanyl group (OX) and radically polymerizable acryloyl group (AC), methacryloyl group (MAC), or a cationically polymerizable oxetanyl group (OX), the silica hybrid composite can be cured by irradiating light such as ultraviolet light.

In a filter membrane according to an embodiment of the present invention, a diameter (r₁) of each of the opening parts is desirably 0.1-10.0 μm.

In the present specification, a diameter of an opening part means a diameter of the opening part at the second surface.

Therefore, in FIG. 1B, the diameter (r₁) measured at the second surface 12 is the diameter of the opening part 13.

A value of the diameter (r₁) of each of the opening parts can be measured from a photograph obtained by photographing the second surface of the filter membrane using a scanning electron microscope (SEM).

A shape of each of the opening parts viewed from the second surface is not particularly limited, and may be a circle, an ellipse, a racetrack, or shapes formed from other curves. The shape of each of the opening parts viewed from the second surface may be a polygon such as a quadrangle. However, in order to smoothly perform filtration, a shape formed by a curve such as a circle, an ellipse or the like is preferable.

Further, in a filter membrane according to an embodiment of the present invention, when the shape of each of the opening parts viewed from the second surface in a plan view is not a circle, a width of a narrowest portion is taken as the diameter (r₁) of each of the opening parts.

In a filter membrane according to an embodiment of the present invention, when the diameter (r₁) of each of the opening parts is 0.1-10.0 μm, extremely fine dust, viruses and the like can be removed from a gas or the like containing the dust, the viruses and the like. Further, fine components in a liquid such as those that form cells can also be selectively separated by filtration.

In a filter membrane according to an embodiment of the present invention, when the diameter (r₁) of each of the opening parts is less than 0.1 μm, since the diameter of each of the opening parts is too small, when attempting to form accurate opening parts, cost for forming the opening parts becomes excessively high. On the other hand, when the diameter (r₁) of each of the opening parts exceeds 10.0 μm, since the diameter of each of the opening parts becomes too large and filtration becomes easy, even when a filter membrane having the opening parts and the expansion parts as in an embodiment of the present invention is fabricated, features of a filter membrane according to an embodiment of the present invention cannot be fully demonstrated.

In a filter membrane according to an embodiment of the present invention, a relation between an interval (d) between the opening parts and the diameter (r₁) of each of the opening parts is desirably 0.2r₁≤d≤1.2r₁.

In a filter membrane according to an embodiment of the present invention, when the relation between the interval (d) between the opening parts and the diameter (r₁) of each of the opening parts is 0.2r₁≤d≤1.2r₁, the number of the opening parts per unit area is sufficiently large and mechanical strength can also be maintained, and filtration can be efficiently performed using a filter membrane excellent in durability.

In the present specification, the interval between the opening parts means an interval between the opening parts at the second surface.

Therefore, in FIG. 1B, the interval (d) between the opening parts measured at the second surface 12 is the interval between the opening parts.

A value of the interval (d) between the opening parts can be measured from a photograph obtained by photographing the second surface of the filter membrane using a scanning electron microscope (SEM).

When the interval (d) between the opening parts is less than 0.2r₁ with respect to the diameter (r₁) of each of the opening parts, since the interval (d) is too short, the filter membrane is decreased in strength and can be easily broken. On the other hand, when the interval (d) between the opening parts exceeds 1.2r₁ with respect to the diameter (r₁) of each of the opening parts, since the interval between the opening parts is too wide, the number of the opening parts per unit area decreases and efficiency of filtration decreases.

In a filter membrane according to an embodiment of the present invention, a thickness (t₁) of a portion where only the opening parts are formed is preferably 1-4 μm and a thickness (t₂) of a portion where only the expansion parts are formed is preferably 3-16 μm.

In a filter membrane according to an embodiment of the present invention, when the thickness (t₁) of the portion where only the opening parts are formed is 1-4 μm and the thickness (t₂) of the portion where only the expansion parts are formed is 3-16 μm, filtration can be efficiently performed using a filter membrane having sufficient mechanical strength and excellent durability.

As illustrated in FIG. 1B, when a bottom surface (14a) of each of the expansion parts 14 is formed parallel to the second surface 12, a distance between the bottom surface (14a) and the second surface 12 becomes the thickness (t₁) of the portion where only the opening parts are formed, and a distance between the bottom surface (14a) and the first surface 11 becomes the thickness (t₂) of the portion where only the expansion parts are formed.

FIG. 2 is a cross-sectional view schematically illustrating a shape of a cross section that includes an opening and is perpendicular to the second surface in a filter membrane according to an embodiment of the present invention.

As illustrated in FIG. 2, in a filter membrane 20 according to an embodiment of the present invention, when a bottom surface (24a) of each of expansion parts 24 is not parallel to a second surface 22, in a cross section perpendicular to the second surface 22, a shortest distance between a point (p), at which a line obtained by extending the bottom surface (24a) and a line obtained by extending a wall surface (24b) of the each of the expansion parts 24 (the wall surface (24b) being connected to a first surface 21) intersect, and the second surface 22 is taken as the thickness (t₁) of the portion where only the opening parts are formed, and a value (T−t₁) obtained by subtracting the thickness (t₁) of the portion where only the opening parts are formed from a thickness (T) between the first surface 21 and the second surface 22 is taken as the thickness (t₂) of the portion where only the expansion parts are formed.

When the thickness (t₁) of the portion where only the opening parts are formed is less than 1 μm, the thickness (t₁) of the opening parts is too small and there is a risk that cracks or the like may form in the opening parts during filtration. On the other hand, when the thickness (t₁) of the portion where only the opening parts are formed exceeds 4 μm, the thickness (t₁) of the opening parts is too large and it is difficult for substances to be filtered to escape from the opening parts. Therefore, it is possible that filtration does not proceed smoothly.

When the thickness (t₂) of the portion where only the expansion parts are formed is less than 3 μm, the volume of the expansion parts is decreased and thus, during filtration, the filter membrane is likely to be clogged with substances not to be filtered. On the other hand, when the thickness (t₂) of the portion where only the expansion parts are formed exceeds 16 μm, the volume of the expansion parts becomes too large and it becomes difficult to manufacture the filter membrane and thus the filter membrane becomes expensive.

In a filter membrane according to an embodiment of the present invention, an aspect ratio (t₁/r₁) of each of the opening parts is desirably 8 or less.

In a filter membrane according to an embodiment of the present invention, when the aspect ratio (t₁/r₁) of each of the opening parts is 8 or less, each of the opening parts is not too thin and too long and thus, the filter membrane is unlikely to be clogged with substances not to be filtered.

The thickness (t₁) of the portion where only the opening parts are formed is specified as described above, and the diameter (r₁) of each of the opening parts is also specified as described above. Therefore, in the present specification, the aspect ratio (t₁/r₁) is clearly specified.

When the aspect ratio (t₁/r₁) of each of the opening parts exceeds 8, the thickness (t₁) of the portion where only the opening parts are formed is too large as compared to the diameter (r₁) of each of the opening parts. Therefore, it is difficult for substances to be filtered to escape from the opening parts and it is difficult to efficiently perform filtration.

In a filter membrane according to an embodiment of the present invention, in a shape of a cross section that includes one of the openings and is perpendicular to the second surface, an angle formed by a wall surface of the expansion part continuing from the first surface and the first surface is desirably 43-80 degrees.

In FIGS. 1B and 2, the angle formed by the wall surface (24b) of the expansion part 24 continuing from the first surface 21 and the first surface 21 is indicated using α. In FIG. 2, when a boundary portion between the expansion part 24 and the first surface 21 is formed by a curve, the angle formed by the wall surface (24b) of the expansion part 24 continuing from the first surface 21 and the first surface 21 is an angle formed by a straight line obtained by extending a linear portion of the expansion part 24 to the first surface 21 and the first surface 21.

In a filter membrane according to an embodiment of the present invention, when the angle (α) formed by the wall surface of the expansion part continuing from the first surface and the first surface is 43-80 degrees, of the expansion part continuing from the first surface, a cross-sectional area of a cross section parallel to the first surface becomes broader with decreasing distance from the first surface. Therefore, even when substances not to be filtered larger than the opening parts formed on the first surface approach the first surface, voids are likely to be formed between the opening parts and the substances not to be filtered, the opening parts are unlikely to be blocked, filtration can be continuously performed over a long time period, and a filtration process can be efficiently performed.

In a filter membrane according to an embodiment of the present invention, when the angle (α) formed by the wall surface of the expansion part continuing from the first surface and the first surface is less than 43 degrees, the expansion part rapidly expands with decreasing distance from the first surface and thus, when substances not to be filtered approach the first surface, the opening parts are likely to be blocked.

On the other hand, when the angle (α) formed by the wall surface of the expansion part continuing from the first surface and the first surface exceeds 80 degrees, the wall surface of the expansion part continuing from the first surface is formed at an angle nearly perpendicular to the first surface and thus, substances not to be filtered are likely to fit in the expansion parts and clogging in the opening parts is likely to occur.

Further, an angle formed by the second surface and a wall surface of an opening part is also desirably 43-80 degrees. Since an inlet of the opening part is slightly larger than an outlet of the opening part, substances to be filtered having diameters equal to or less than a predetermined diameter are likely to easily pass through without causing clogging.

In a filter membrane according to an embodiment of the present invention, a ratio of an area (a₁) where the opening parts are formed to a total area (A) of the filter membrane in a plan view is desirably 4-30%.

In a filter membrane according to an embodiment of the present invention, when the ratio of the area (a₁) where the opening parts are formed to the total area (A) of the filter membrane in a plan view is 4-30%, an area of the opening parts per unit area of the entire opening parts is sufficiently large and the mechanical strength can also be maintained, and filtration can be efficiently performed using a filter membrane excellent in durability.

In a filter membrane according to an embodiment of the present invention, when the ratio of the area (a₁) where the opening parts are formed to the total area (A) of the filter membrane in a plan view is less than 4%, since the area of the opening parts is too small, it is difficult to efficiently perform filtration. On the other hand, when the ratio of the area (a₁) where the opening parts are formed to the total area (A) of the filter membrane in a plan view exceeds 30%, since the area of the opening parts is too large, an area of a portion supporting the filter membrane becomes small, and the filter membrane is decreased in mechanical strength and can be easily broken.

In a filter membrane according to an embodiment of the present invention, a ratio of an area (a₂) where the expansion parts are formed to the total area (A) of the filter membrane in a plan view is desirably 20-80%.

In a filter membrane according to an embodiment of the present invention, when the ratio of the area (a₂) where the expansion parts are formed to the total area (A) of the filter membrane in a plan view is 20-80%, since the area of the expansion parts is sufficiently large, clogging or the like is unlikely to occur in the filter membrane and a filtration operation can be efficiently performed.

In a filter membrane according to an embodiment of the present invention, when the ratio of the area (a₂) where the expansion parts are formed to the total area (A) of the filter membrane in a plan view is less than 20%, the volume of the expansion parts becomes too small and it becomes difficult to obtain the effect according to an embodiment of the present invention that, due to the presence of the expansion parts, when the filter membrane is used for inspection, experiment or the like, the opening parts are unlikely to be blocked by substances not to be filtered.

On the other hand, when the ratio of the area (a₂) where the expansion parts are formed to the total area (A) of the filter membrane in a plan view exceeds 80%, the volume of the expansion parts becomes too large and a volume of a thick continuous portion containing the first surface becomes too small so that the self-reliance of the filter membrane is greatly reduced.

Next, a specific shape of a filter membrane according to an embodiment of the present invention is described.

In a filter membrane according to an embodiment of the present invention, it is desirable that, in a plan view of the filter membrane, multiple island-shape portions that form the first surface be interspersed between the expansion parts.

That is, an example of a filter membrane according to a first embodiment of the present invention is a filter membrane having a structure in which, in a plan view of the filter membrane, multiple square island-shape portions, which form the first surface, are interspersed in a state of being aligned in vertical and horizontal directions; in a portion other than the island-shape portions, an opening including circular opening parts and an expansion part is formed; and in the expansion part, the opening parts are regularly arrayed in vertical and horizontal directions.

Further, an example of a filter membrane according to a second embodiment of the present invention is a filter membrane that has a structure that is almost the same as that of the filter membrane according to the first embodiment, but in which a formation of island-shape portions is different; when the formation in a lateral direction is observed, island-shape portions in an uppermost row and island-shape portions in a next lower row are arrayed at positions shifted by half a pitch from each other between the two rows; an island-shape portion in a lower row is formed between two island-shape portions in an upper row; in a portion other than the island-shape portions, an opening including opening parts and an expansion part are formed; and in the expansion part, the opening parts are regularly formed in vertical and horizontal directions.

Further, an example of a filter membrane according to a third embodiment of the present invention is a filter membrane in which a formation of island-shape portions is the same as that in the filter membrane according to the second embodiment, and that opening parts are formed in an expansion part is the same as that in the filter membranes according to the first embodiment and the second embodiment, but that a shape of each of the opening parts in a plan view is an ellipse is different from the filter membranes according to the first embodiment and the second embodiment; and two types of the opening parts with their elliptical shapes oriented in directions different by 90 degrees from each other are formed according to a certain rule.

Further, an example of a filter membrane according to a fourth embodiment of the present invention is a filter membrane in which a formation of island-shape portions is the same as that in the filter membrane according to the first embodiment, and that opening parts are formed in an expansion part is the same as that in the filter membranes according to the first embodiment and the second embodiment, but that a shape of each of the opening parts in a plan view is an ellipse is the same as in the filter membrane according to the third embodiment; and two types of the opening parts with their elliptical shapes oriented in directions different by 90 degrees from each other are formed according to a certain rule.

In the filter membranes having such structures, substances in a filtration processing fluid larger than the openings are in a state of being supported by the island-shape portions during a filtration process regardless of which part of the filter membranes the substances reach. In a portion other than the island-shape portions, the expansion part having a large volume exists and thus, void portions are likely to exist and fluid flows in an opening direction via the void portions. Therefore, the substances larger than the opening parts are unlikely to block the opening parts, a filtration process can be more efficiently performed, and data with good reproducibility can be obtained.

The filter membrane is further described in detail with reference to the drawings.

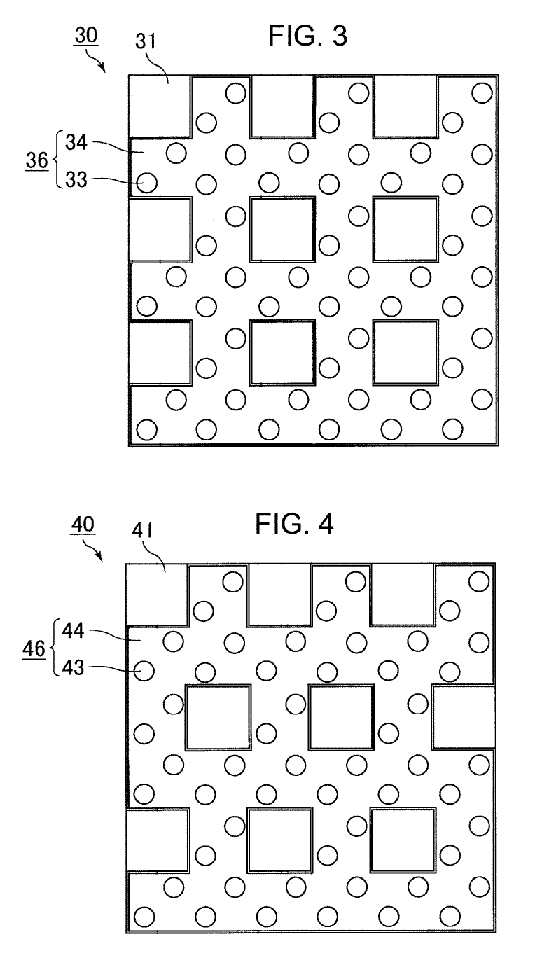

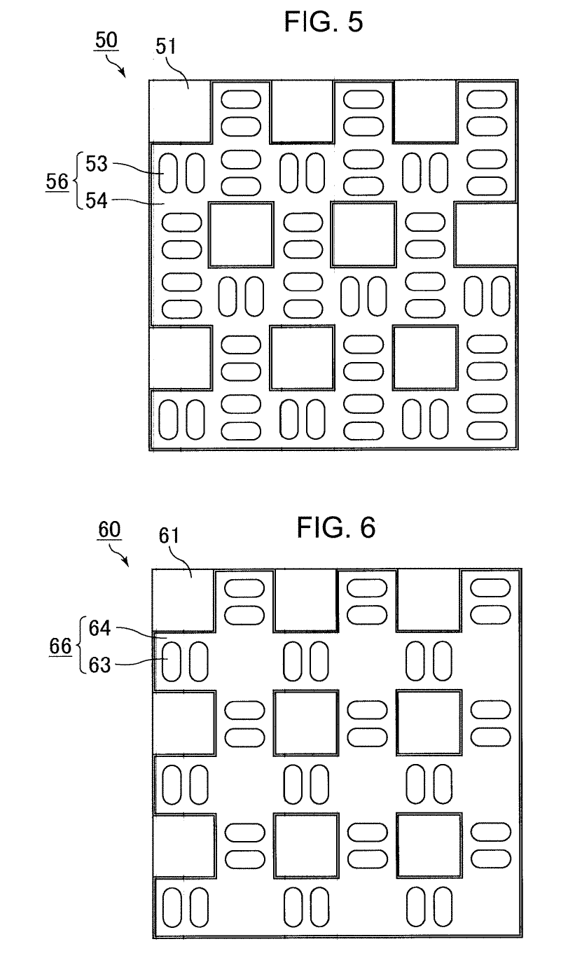

FIG. 3 is a plan view schematically illustrating the filter membrane according to the first embodiment of the present invention. FIG. 4 is a plan view schematically illustrating the filter membrane according to the second embodiment of the present invention. Further, FIG. 5 is a plan view schematically illustrating the filter membrane according to the third embodiment of the present invention. FIG. 6 is a plan view schematically illustrating a filter membrane according to a fourth embodiment of the present invention.

In a filter membrane 30 according to the first embodiment of the present invention illustrated in FIG. 3, in a plan view of the filter membrane 30, multiple square island-shape portions 31, which form the first surface, are interspersed in a state of being aligned in vertical and horizontal directions. In a portion other than the island-shape portions 31, an opening 36 including circular opening parts 33 and an expansion part 34 is formed. In the expansion part 34, the opening parts 33 are regularly arrayed in vertical and horizontal directions.

A filter membrane 40 according to the second embodiment of the present invention illustrated in FIG. 4 has a structure that is almost the same as that of the filter membrane 30 illustrated in FIG. 3. However, a formation of island-shape portions 41 is different. When the array in a lateral direction is observed, island-shape portions 41 in an uppermost row and island-shape portions 41 in a next lower row are arrayed at positions shifted by half a pitch from each other between the two rows. An island-shape portion 41 in a lower row is formed between two island-shape portions 41 in an upper row. In a portion other than the island-shape portions 41, an opening 46 including opening parts 43 and an expansion part 44 is formed. That the opening parts 43 are regularly arrayed in vertical and horizontal directions in the expansion part 44 is the same as in the case of the filter membrane 30 illustrated in FIG. 3.

In a filter membrane 50 according to the third embodiment of the present invention illustrated in FIG. 5, a formation of island-shape portions 51 is the same as FIG. 4, and that opening parts 53 are formed in an expansion part 54 is the same as that in the filter membranes (30, 40) illustrated in FIGS. 3 and 4. However, that a shape of each of the opening parts 53 in a plan view is an ellipse is different from the filter membranes (30, 40) illustrated in FIGS. 3 and 4. Further, two types of the opening parts 53 with their elliptical shapes oriented in directions different by 90 degrees from each other are arrayed according a certain rule.

In a filter membrane 60 according to the fourth embodiment of the present invention illustrated in FIG. 6, a formation of island-shape portions 61 is the same as FIG. 3, and that opening parts 63 are formed in an expansion part 64 is the same as that in the filter membranes (30, 40) illustrated in FIGS. 3 and 4. However, that a shape of each of the opening parts 63 in a plan view is an ellipse is the same as the filter membrane 50 illustrated in FIG. 5. Further, the opening parts 63 with their elliptical shapes oriented in directions different by 90 degrees from each other are arrayed according a certain rule.

In such filter membranes (30, 40, 50, 60) according to the embodiments illustrated in FIG. 3-6, substances in a filtration processing fluid larger than the openings (36, 46, 56, 66) are in a state of being supported by the island-shape portions (31, 41, 51, 61) during a filtration process regardless of which part of the filter membranes (30, 40, 50, 60) the substances reach. In portions other than the island-shape portions (31, 41, 51, 61), the expansion parts (34, 44, 54, 64) having large volumes exist and thus, void portions are likely to exist and fluid flows in an opening direction via the void portions. Therefore, the substances larger than the opening parts (33, 43, 53, 63) are unlikely to block the opening parts (33, 43, 53, 63), a filtration process can be more efficiently performed, and data with good reproducibility can be obtained.

Further, a filter membrane according to an embodiment of the present invention desirably has a repeating structure in which, in a plan view of the filter membrane, a strip-shape portion, which has a predetermined width and forms a portion of the first surface, and an expansion part are repeated multiple times.

An example of a filter membrane according to the fifth embodiment of the present invention is a filter membrane in which, in a plan view, three strip-shape portions, each having a predetermined width and forming a portion of the first surface, are formed substantially in parallel in an vertical direction, and strip-shape openings, each including circular opening parts and an expansion part, are formed between the strip-shape portions. The opening parts are formed in two rows in a vertical direction in the expansion part and the two rows of the opening parts are shifted by half a pitch from each other. When the opening parts in a plan view are traced, a zigzag shape is formed.

An example of a filter membrane according to the sixth embodiment of the present invention is a filter membrane in which, in a plan view, three strip-shape portions, each having a predetermined width and forming a portion of the first surface, are formed substantially in parallel in an vertical direction, and strip-shape openings, each including elliptical opening parts and an expansion part, are formed between the strip-shape portions. The opening parts are formed in one row in a vertical direction in the expansion part.

That is, each of the filter membranes according to the fifth and sixth embodiments of the present invention has a repeating structure in which, in a plan view of the filter membrane, a strip-shape portion having a predetermined width, which forms a portion of the first surface, and an expansion part are repeated multiple times, and the first surface (the strip-shape portions) forms a stripe pattern.

In each of the above-described filter membranes according to the fifth and sixth embodiments of the present invention, in a plan view of the filter membrane, the first surface (strip-shape portions) forms a stripe pattern in which a predetermined shape is repeated multiple times. Therefore, the stripe pattern has excellent mechanical properties with respect to a direction perpendicular to a repetition direction. By utilizing the above-described property to install the filter membrane on a filter device or the like while stretching the filter membrane in the direction perpendicular to the repetition direction of the repeating structure, the filter membrane can be used as a filter without causing breakage or the like to the filter membrane.

Further, in a plan view of each of the above-described filter membranes, the first surface (strip-shape portions) forms a stripe pattern. Therefore, substances in a filtration processing fluid larger than the openings are in a state of being supported by the strip-shape portions of the first surface of the stripe pattern. In portions other than the strip-shape portions of the first surface, the expansion parts exist and thus, void portions are likely to exist and fluid flows in an opening direction via the void portions. Therefore, the substances larger than the opening parts are unlikely to block the openings, a filtration process can be more efficiently performed, and data with good reproducibility can be obtained.

The above-described filter membranes according to the fifth and sixth embodiments of the present invention are further described in detail with reference to the drawings.

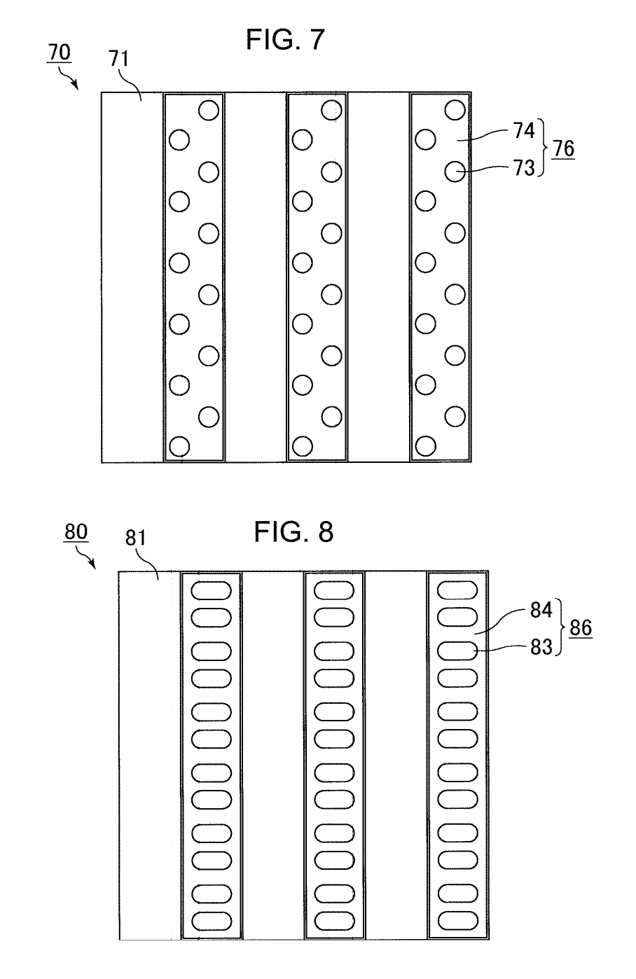

FIG. 7 is a plan view schematically illustrating the filter membrane according to the fifth embodiment of the present invention. FIG. 8 is a plan view schematically illustrating the filter membrane according to the sixth embodiment of the present invention.

In a filter membrane 70 according to the fifth embodiment of the present invention illustrated in FIG. 7, in a plan view, three strip-shape portion 71, each having a predetermined width and forming a portion of the first surface, are formed substantially in parallel in an vertical direction, and strip-shape openings 76, each including circular opening parts 73 and an expansion part 74, are formed between the strip-shape portions 71. The opening parts 73 are formed in two rows in a vertical direction in the expansion part 74 and the two rows of the opening parts 73 are shifted by half a pitch from each other. When the opening parts 73 in a plan view are traced, a zigzag shape is formed.

In a filter membrane 80 according to the sixth embodiment of the present invention illustrated in FIG. 8, in a plan view, three strip-shape portion 81, each having a predetermined width and forming a portion of the first surface, are formed substantially in parallel in an vertical direction, and strip-shape openings 86, each including elliptical opening parts 83 and an expansion part 84, are formed between the strip-shape portions 81. The opening parts 83 are formed in one row in a vertical direction in the expansion part 84.

That is, each of the filter membranes (70, 80) according to the fifth and sixth embodiments of the present invention has a repeating structure in which, in a plan view of the each of the filter membranes (70, 80), a strip-shape portion (71 or 81) having a predetermined width, which forms a portion of the first surface, and an expansion part (74 or 84) are repeated multiple times, and the first surface (the strip-shape portions (71 or 81)) forms a stripe pattern.

In each of the above-described filter membranes (70, 80) according to the fifth and sixth embodiments of the present invention, in a plan view of the each of the filter membranes (70, 80), the first surface (strip-shape portions (71 or 81)) forms a stripe pattern in which a predetermined shape is repeated multiple times. Therefore, the stripe pattern has excellent mechanical properties with respect to a direction perpendicular to a repetition direction. By utilizing the above-described property to install the filter membrane (70 or 80) on a filter device or the like while stretching the filter membrane (70 or 80) in the direction perpendicular to the repetition direction of the repeating structure, the filter membrane (70 or 80) can be used as a filter without causing breakage or the like to the filter membrane (70 or 80).

Further, in a plan view of each of the above-described filter membranes (70, 80), the first surface (strip-shape portions (71 or 81)) forms a stripe pattern. Therefore, substances in a filtration processing fluid larger than the openings are in a state of being supported by the strip-shape portions (71 or 81) of the first surface of the stripe pattern. In portions other than the strip-shape portions (71 or 81) of the first surface, the expansion parts (74 or 84) exist and thus, void portions are likely to exist and fluid flows in an opening direction via the void portions. Therefore, the substances larger than the opening parts (73 or 83) are unlikely to block the opening parts (73 or 83), a filtration process can be more efficiently performed, and data with good reproducibility can be obtained.

Filter membranes of the present invention are not limited the above-described filter membranes according to the first-sixth embodiments as long as the first surface is divided into two or more regions. However, in plan views of the above-described filter membranes, a filter membrane having a structure in which multiple island-shape portions that form the first surface are interspersed between the expansion parts, or a filter membrane having a repeating structure in which a strip-shape portion having a predetermined width, which forms a portion of the first surface, and an expansion part are repeated multiple times, is desirable.

Next, a method for manufacturing the above-described filter membranes is described.

A method for manufacturing the above-described filter membrane desirably includes: a master mold fabrication process in which a master mold is fabricated including a flat plate-shaped substrate part and a filter membrane part that is formed on the substrate part and has the same structure as the above-described filter membrane according to an embodiment of the present invention; a transfer mold fabrication process in which a mirror image mold is fabricated by thermally laminating a transparent thermoplastic resin film is on the master mold fabricated by the above master mold fabrication process to transfer a concave-convex shape of the master mold and thereafter peeling off the thermoplastic resin film; and a filter membrane fabrication process in which a filter membrane having the same structure as the above-described filter membrane according to an embodiment of the present invention is fabricated on a substrate part by pressing the mirror image mold against a photosensitive resin layer that is formed of a photosensitive resin and is formed on the substrate part and thereafter curing the photosensitive resin layer.

In the above-described method for manufacturing the filter membrane, a final filter membrane can be manufactured using the same mirror image mold fabricated via the transfer mold fabrication process using the master mold fabricated in the master mold fabrication process. Therefore, a filter membrane having a structure such as the shape of the opening parts as designed can be can be manufactured with good reproducibility.

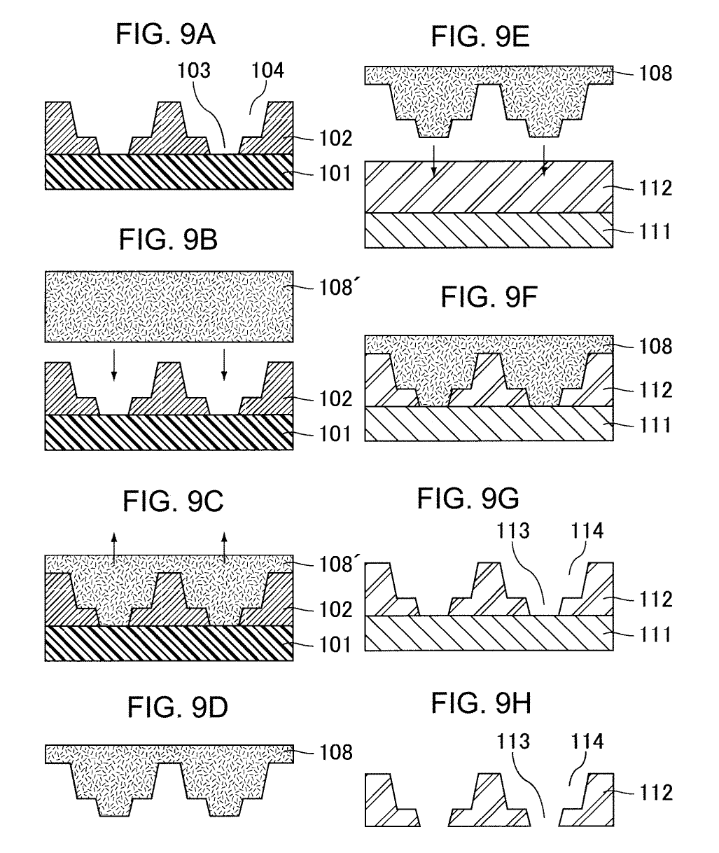

FIG. 9A-9H are cross-sectional views schematically illustrating processes in the method for manufacturing the above-described filter membranes.

(1) Master Mold Fabrication Process

In the method for manufacturing the above-described filter membranes, as the master mold fabrication process, a master mold is fabricated including a flat plate-shaped substrate part and a filter membrane part that is formed on the substrate part and has the same structure as the filter membrane according to an embodiment of the present invention.

A method for fabricating the master mold is not particularly limited. However, a method can be adopted in which a resin master mold is fabricated on the substrate part using a photolithography and/or etching method.

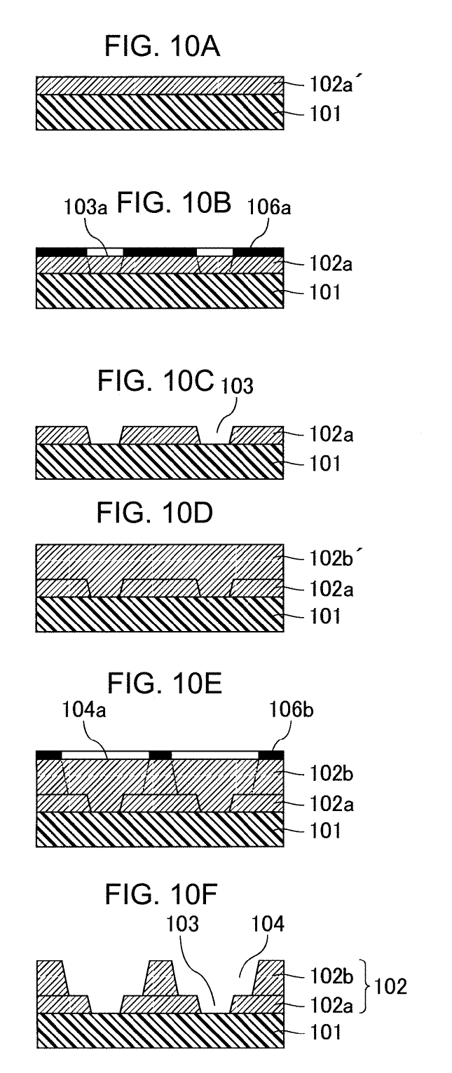

FIG. 10A-10F are cross-sectional views schematically illustrating a two-stage master mold fabrication process in an example of the method for manufacturing the filter membrane. In the manufacturing method illustrated in FIGS. 9A-9H and 10A-10F, as a master mold, a resin master mold is fabricated.

A resin that forms the master mold is not particularly limited. However, the same resin material as the resin material that forms a filter membrane according to an embodiment of the present invention can be used. Examples of the resin material include a silicone-based resin, an acrylic resin, a phenol resin, a polyimide resin, a silica hybrid composite and the like. These resins are highly flexible and thus have excellent mechanical properties and are unlikely to be worn away even when being used many times in mirror image mold fabrication.

These silicone-based resin, acrylic resin, phenol resin, polyimide resin and silica hybrid composite have been described in detail in the description about the resin material that forms a filter membrane according to an embodiment of the present invention. Therefore, the description about these materials is omitted here. In the following processes, among the above-described resins, a photosensitive resin of a negative type is used.

In this master mold fabrication process, first, on a substrate part 101, after a coating liquid is prepared by dissolving the resin in a solvent or the like, the coating liquid is applied and dried, and a coating layer (102a′) for forming the opening parts is formed (see FIG. 10A). After the formation of the coating layer (102a′), the coating layer (102a′) is cured to form a cured resin layer (102a). A glass plate (106a), which is patterned so as to expose a cured resin layer surface (103a) having the shape of the opening parts in a plan view, is set as a mask and exposure is performed (see FIG. 10B). As a light source for the exposure, a lamp or the like is used.

A material of the substrate part 101 is not particularly limited, and examples thereof include thermosetting resins such as a bismaleimide triazine resin, an epoxy resin and a silicone resin, metals such as silicon, ceramics such as alumina and glass, and the like.

Next, the cured resin layer (102a) is brought into contact with a liquid developer for a predetermined time period to dissolve and remove a portion including the cured resin layer surface (103a) to form recesses (opening parts) 103 (see FIG. 10C).

Next, again, the coating liquid is applied and dried to form a coating layer (102b′) for forming the expansion parts (see FIG. 10D). Next, the coating layer (102b′) is cured to form a cured resin layer (102b). A glass plate (106b), which is patterned so as to expose a cured resin layer surface (104a) having the shape of the expansion parts, is set as a mask and exposure is performed (see FIG. 10E).

Next, the cured resin layer (102b) is brought into contact with a liquid developer for a predetermined time period to dissolve and remove a portion including the cured resin layer surface (104a) to form recesses (expansion parts) 104 and the opening parts 103. As a result, fabrication of a master mold 102 having the opening parts 103 and the expansion parts 104 is completed (see FIGS. 10F and 9A). The cured resin layer (102a) has been subjected to a treatment such that the cured resin layer (102a) is not dissolved in the second exposure. Further, the substrate part 101 needs to be formed of a material that is not etched even when the material is in contact with the liquid developer.

In the above process, the master mold is fabricated by performing coating layer formation twice and development processing twice. However, it is also possible that the opening parts and the expansion parts are formed by performing development processing once.

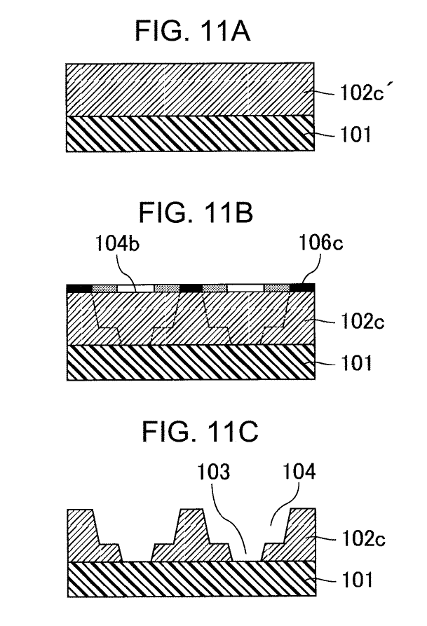

FIG. 11A-11C are cross-sectional views schematically illustrating a one-stage master mold fabrication process in a method for manufacturing a filter membrane according to an embodiment of the present invention.

In this master mold fabrication process, first, on the substrate part 101, after a coating liquid is prepared by dissolving the resin in a solvent or the like, the coating liquid is applied and dried, and a coating layer (102c′) for forming the opening parts and the expansion parts is formed (see FIG. 11A). After the formation of the coating layer (102c′), the coating layer (102c′) is cured to form a cured resin layer (102c), and a glass plate (106c), which is patterned so as to expose a cured resin layer surface (104b), is set as a mask and exposure is performed. However, in this case, as the pattern of the glass plate (106c), a pattern is formed having shading that is different between a portion for an expansion part and a portion for an opening part, and exposure is performed. Thereby, the portions for the opening parts and the portions for the expansion parts can be collectively exposed (see FIG. 11B).

Thereafter, the cured resin layer (102c) is brought into contact with a liquid developer for a predetermined time period to dissolve and remove a portion including the exposed cured resin layer surface (104b) of the cured resin layer (102c) to form the expansion parts 104 and the opening parts 103. As a result, fabrication of a master mold (102c) having the opening parts 103 and the expansion parts 104 is completed (see FIGS. 11C and 9A).

In the above-described master mold fabrication process, a master mold is fabricated by exposure and development using a patterned glass plate as a mask. However, it is also possible that a master mold is fabricated by subjecting a specific region such as a portion for an opening part to irradiation, exposure, and development processing using a focused light source such as a laser light source without using a mask. When recesses such as the opening parts and the expansion part having different depths are formed, by adjusting output of laser or the like according to a place to be irradiated, an exposure depth can be adjusted. As a result, the opening parts and the expansion parts can be formed at once.

(2) Transfer Mold Fabrication Process

In a transfer mold fabrication process according to an embodiment of the present invention, a transparent thermoplastic resin film 108′ (see FIG. 9B) is used to transfer a concave-convex shape of the master mold 102 fabricated by the master mold fabrication process by thermally laminating the thermoplastic resin film 108′ on the master mold (see FIG. 9C). Thereafter, by peeling off the thermoplastic resin film 108′, a mirror image mold 108 is fabricated (see FIG. 9D).

Examples of materials for the transparent thermoplastic resin film include cycloolefin polymers, polyvinyl chloride (PVC), polycarbonate (PC) based resins, polyamide resins, acrylic resins such as polymethyl methacrylate resins, polystyrene resins, and the like.

In the above process, the master mold is fabricated by thermally laminating the transparent thermoplastic resin film 108′. However, it is also possible that the mirror image mold 108 is fabricated by applying a liquid resin on the master mold 102 and curing the resin and then peeling off the resin. According to this method, the mirror image mold 108 can be fabricated by using a thermosetting resin such as a silicone resin.

A temperature of the thermal lamination is preferably 80-200° C., and a time period of the thermal lamination is preferably from 0.5-5 minutes.

(3) Filter Membrane Fabrication Process

In a filter membrane fabrication process according to an embodiment of the present invention, the transparent mirror image mold 108 is pressed against a photosensitive resin layer 112′ that is formed of a photosensitive resin and is formed on another substrate part 111 (see FIG. 9E). Thereafter, ultraviolet light or the like is irradiated via the transparent mirror image mold 108 to cure the photosensitive resin layer 112′ (see FIG. 9F). A filter membrane 112 having the same structure as the filter membrane is fabricated on the substrate part 111 (see FIG. 9G). By peeling off the substrate part 111, fabrication of the filter membrane 112 according to an embodiment of the present invention in which the opening parts 113 and the expansion parts 114 are formed is completed (see FIG. 9H).

The photosensitive resin layer 112′ can be formed by applying a photosensitive resin dissolved in a solvent on the substrate part 111 and drying the photosensitive resin. Examples of the photosensitive resin include an acrylic resin, a phenol resin, a polyimide resin, a silica hybrid composite and the like.

A material of the another substrate part 111 is not particularly limited, and examples thereof include thermosetting resins such as a bismaleimide triazine resin, an epoxy resin and a silicone resin, metals such as silicon, ceramics such as alumina and glass, and the like.

In the above filter membrane fabrication process, a photosensitive resin is used. However, it is also possible that a thermosetting silicone-based resin or the like is used and, after pressing the mirror image mold 108 against the resin, the resin is cured by heating or the like.

In a method for manufacturing a filter membrane according to an embodiment of the present invention, in the master mold fabrication process, it is also possible to a photolithography and/or etching method to fabricate a silicon or glass master mold in which the substrate part and the filter membrane part are integrally formed.

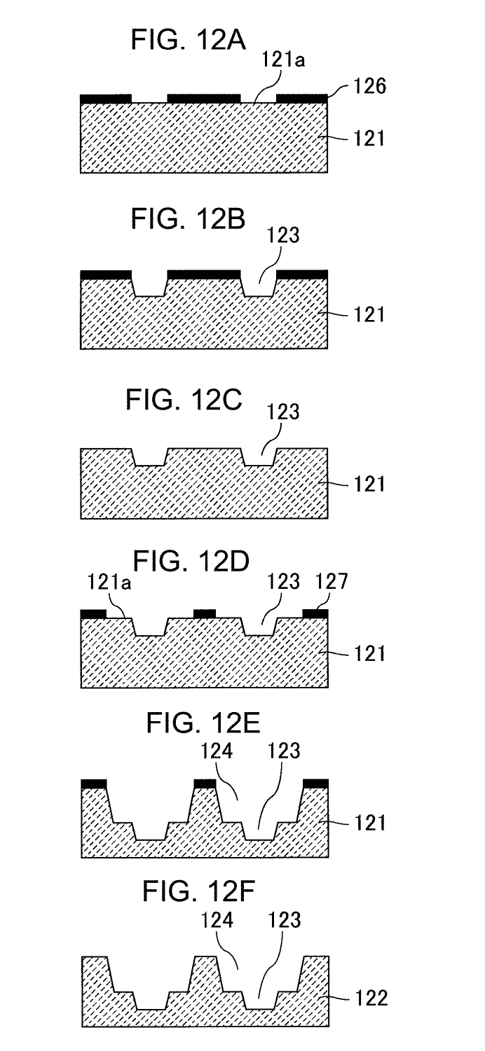

FIG. 12A-12F are cross-sectional views schematically illustrating a master mold fabrication process in a method for manufacturing another filter membrane according to an embodiment of the present invention. In the manufacturing method illustrated in FIG. 12A-12F, as a master mold, a silicon or glass master mold is fabricated.

In the master mold fabrication process, first, using a photolithography method, an etching resist layer 126 is formed on a surface of a silicon or glass base material 121 so as to expose a base material surface (121a) having the shape of the opening parts in a plan view (see FIG. 12A).

A material of the glass is not particularly limited. For example, general purpose glass such as soda glass, heat resistant glass such as quartz glass and tempax may be used.

Next, the base material surface (121a) is brought into contact with an etching gas for a predetermined time period to form recesses (opening parts) 123 in the base material 121 (see FIG. 12B). The etching resist layer 126 is peeled off (see FIG. 12C).

Next, using a photolithography method, another etching resist layer 127 is formed on the base material 121 having the recesses (opening parts) 123 so as to expose the base material surface (121a) having the shape of the expansion parts (see FIG. 12D).

Next, by bringing the base material surface (121a) on which the etching resist layer 127 is formed into contact with an etching gas for a predetermined time period, the expansion parts 124 and the opening parts 123 having predetermined depths are formed in the base material 121 (FIG. 12E). By peeling off the etching resist layer 127, a silicon or glass master mold 122 having the opening parts 123 and the expansion parts 124 is fabricated (FIG. 12F).

In the fabricated master mold, a substrate part and a filter membrane part are integrally formed.

A method for manufacturing a filter membrane according to an embodiment of the present invention using the obtained master mold 122 is the same as the method for manufacturing the filter membrane described above using FIG. 9A-9H and thus a description thereof is omitted here.

### EXAMPLES

In the following, examples that more specifically disclose the present invention are described. The present invention is not limited to these examples.

### Example 1

(1) Master Mold Fabrication Process

On a surface of a substrate part 101 formed of a bismaleimide triazine resin, a coating liquid prepared by dissolving a photosensitive acrylic resin in diethylene glycol dimethyl ether was applied and dried to form a coating layer 102′ (FIG. 10A). After the formation of the coating layer (102a′), the coating layer (102a′) was cured to form a cured resin layer (102a). A glass plate (106a), which was patterned so as to expose a cured resin layer surface (103a) having the shape of the opening parts in a plan view, was set as a mask and exposure is performed (see FIG. 10B).

Next, the cured resin layer (102a) was brought into contact with a liquid developer for a predetermined time period to dissolve and remove a portion including the cured resin layer surface (103a) to form recesses (opening parts) 103 (see FIG. 10C). Thereafter, the coating layer (102a′) was subjected to a heat treatment to form a cured resin layer (102a).

Next, again, the coating liquid was applied and dried to form a coating layer (102b′) for forming the expansion parts (see FIG. 10D). Next, the coating layer (102b′) was cured to form a cured resin layer (102b). A glass plate (106b), which was patterned so as to expose a cured resin layer surface (104a) having the shape of the expansion parts, was set as a mask and exposure was performed (see FIG. 10E).

Next, the cured resin layer (102b) was brought into contact with a liquid developer for a predetermined time period to dissolve and remove a portion including the cured resin layer surface (104a) to form recesses (expansion parts) 104 and the opening parts 103. As a result, fabrication of a master mold 102 having the opening parts 103 and the expansion parts 104 was completed (see FIGS. 10F and 9A). The cured resin layer (102a) had been subjected to a treatment such that the cured resin layer (102a) was not dissolved in the second exposure.

(2) Transfer Mold Fabrication Process

In a transfer mold fabrication process according to an embodiment of the present invention, a transparent thermoplastic resin film 108′ (see FIG. 9B) formed of a cycloolefin polymer was used to transfer a concave-convex shape of the master mold 102 fabricated by the master mold fabrication process by thermally laminating the thermoplastic resin film 108′ on the master mold (see FIG. 9C). Thereafter, by peeling off the thermoplastic resin film 108′, a mirror image mold 108 was fabricated (see FIG. 9D).

(3) Filter Membrane Fabrication Process

In a filter membrane fabrication process according to an embodiment of the present invention, the transparent mirror image mold 108 was pressed against a photosensitive resin layer 112′ that was formed of a photosensitive resin and was formed on another substrate part 111 (see FIG. 9E). Thereafter, ultraviolet light or the like was irradiated via the transparent mirror image mold 108 to cure the photosensitive resin layer 112′ (see FIG. 9F). A filter membrane 112 having the same structure as the filter membrane is fabricated on the substrate part 111 (see FIG. 9G). By peeling off the substrate part 111, fabrication of the filter membrane 112 according to an embodiment of the present invention in which the opening parts 113 and the expansion parts 114 were formed was completed (see FIG. 9H).

The obtained filter membrane had the same structure in a plan view as that illustrated in FIG. 3.

In the formed filter membrane 112, the opening parts 113 each had a diameter of 0.5 μm at the second surface.

### Example 2

(1) Master Mold Fabrication Process

On a substrate part 101, after a coating liquid was prepared by dissolving the above-described resin in a solvent or the like, the coating liquid was applied and dried, and a coating layer (102c′) for forming the opening parts and the expansion parts was formed (see FIG. 11A). After the formation of the coating layer (102c′), the coating layer (102c′) is cured to form a cured resin layer (102c), and a glass plate (106c), which is patterned so as to expose a cured resin layer surface (104b), is set as a mask and exposure is performed. However, in this case, as the pattern of the glass plate (106c), a pattern is formed having shading that is different between a portion for an expansion part and a portion for an opening part, and exposure is performed. Thereby, the portions for the opening parts and the portions for the expansion parts can be collectively exposed (see FIG. 11B).

Thereafter, the cured resin layer (102c) was brought into contact with a liquid developer for a predetermined time period to dissolve and remove a portion including the cured resin layer surface (104b) to form the expansion parts 104 and the opening parts 103. As a result, fabrication of a master mold (102c) having the opening parts 103 and the expansion parts 104 was completed (see FIGS. 11C and 9A).

Thereafter, in the same way as in Example 1, (2) the transfer mold fabrication process and (3) the filter membrane fabrication process were performed and the filter membrane according to an embodiment of the present invention was fabricated.

In the formed filter membrane, the opening parts each had a diameter of 0.5 μm at the second surface.

### Example 3

(1) Master Mold Fabrication Process

First, using a photolithography method, an etching resist layer 126 was formed on a surface of a silicon base material 121 so as to expose a base material surface (121a) having the shape of the opening parts in a plan view (see FIG. 12A).

Next, the base material surface (121a) was brought into contact with an etching gas for a predetermined time period to form recesses (opening parts) 123 in the base material 121 (see FIG. 12B). The etching resist layer 126 was peeled off (see FIG. 12C).

Next, using a photolithography method, another etching resist layer 127 was formed on the base material 121 having the recesses (opening parts) 123 so as to expose the base material surface (121a) having the shape of the expansion parts (see FIG. 12D).

Next, by bringing the base material surface (121a) on which the etching resist layer 127 had been formed into contact with an etching gas for a predetermined time period, the expansion parts 124 and the opening parts 123 having predetermined depths were formed in the base material 121 (FIG. 12E). By peeling off the etching resist layer 127, a silicon master mold 122 having the opening parts 123 and the expansion parts 124 was fabricated (FIG. 12F).

Thereafter, in the same way as in Example 1, (2) the transfer mold fabrication process and (3) the filter membrane fabrication process were performed and the filter membrane according to an embodiment of the present invention was fabricated.

In the formed filter membrane, the opening parts each had a diameter of 0.5 μm at the second surface.

A filter membrane may be fabricated by separately fabricating a polymer filter layer and a polymer support layer and laminating and bonding the two layers to each other. However, in order to prevent peeling between the polymer filter layer and the polymer support layer and to prevent breakage of a fabricated filter membrane and to ensure bonding strength, there is a problem that a bonding process becomes complicated.

Further, during the bonding process, the polymer support layer may partially block the pores of the polymer filter layer and variation in pore areas or pore diameters is likely to occur. Therefore, when the filter membrane is used for inspection, experiment or the like, a problem of data with poor reproducibility occurs.

Further, when attempting to fabricate a filter membrane having a relatively thick structure using a photolithography method or an etching method, shapes of the pores may become non-uniform due to distortion during exposure or variation in etching amount or the like. Therefore, similar to the above, when the filter membrane is used for inspection, experiment or the like, there is a problem of data with poor reproducibility.

Further, in a case where only pores are formed on a plane, when the filter membrane is used as a filter, there is a problem that substances larger in shape than the pores may block the pores and filtration in a short time is likely to become difficult.

A filter membrane according to an embodiment of the present invention, when utilized for inspection, experiment or the like, allows a filtration process to efficiently proceed by having openings that are less likely to be blocked by other substances, and allows data with good reproducibility to be obtained.

A filter membrane according to an embodiment of the present invention for solving the above-described object is a filter membrane in which multiple openings are formed and the openings are used to selectively separate a specific material from other materials in a processing medium. The filter membrane has a first surface, which is on a side where the processing medium is supplied, and a second surface, which is on an opposite side of the first surface. A shape of a cross section that includes one of the openings and is perpendicular to the second surface includes at least an opening part, which is formed from the second surface toward the first surface, and an expansion part, which is formed by expanding a size of the opening part before the opening part reaches the first surface. The first surface is divided into two or more regions.

The filter membrane has the first surface, which is on the side where the processing medium is supplied, and the second surface, which is on the opposite side of the first surface, and the shape of the cross section that includes one of the openings and is perpendicular to the second surface includes at least the opening part, which is formed from the second surface toward the first surface, and the expansion part, which is formed by expanding the size of the opening part before the opening part reaches the first surface. Therefore, due to the presence of the expansion parts, when the filter membrane is used for inspection, experiment or the like, the opening parts are unlikely to be blocked by substances not to be filtered and a filtration process can efficiently proceed, and data with good reproducibility can be obtained.

Further, the first surface is divided into two or more regions. Therefore, a volume of the expansion parts increases, the opening parts are more unlikely to be blocked by substances not to be filtered, a filtration process can efficiently proceed, and data with good reproducibility can be obtained.

The filter membrane can be used as a filter membrane for removing dust, viruses, bacteria and the like present in air or a gas of a specific component and a liquid to obtain clean air, gas, liquid and the like, and, conversely, can also be used as a filter membrane for obtaining, by selectively filtering and separating, only particles, viruses, bacteria, cells and the like of specific sizes present in air or a gas of a specific component and a liquid.

In the filter membrane, it is desirable that, in a plan view of the filter membrane, multiple island-shape portions that form the first surface be interspersed between the expansion parts.

In the filter membrane, in a plan view of the filter membrane, when the multiple island-shape portions that form the first surface are interspersed between the expansion parts, substances in a filtration processing fluid larger than the opening parts are in a state of being supported by the island-shape portions when the substances reach the filter membrane during a filtration process. In portions other than the island-shape portions, the expansion parts having large volumes exist and thus, void portions are likely to exist and fluid flows in an opening part direction via the void portions. Therefore, the substances larger than the opening parts are unlikely to block the opening parts, a filtration process can be more efficiently performed, and data with good reproducibility can be obtained.

In the filter membrane, it is desirable that, in a plan view of the filter membrane, the island-shape portions each have a quadrangular shape and be regularly arrayed in vertical and horizontal directions.

In the filter membrane, in a plan view of the filter membrane, when the island-shape portions each have a quadrangular shape and are regularly arrayed in vertical and horizontal directions, substances in a filtration processing fluid larger than the opening parts are in a state of being supported by the island-shape portions during a filtration process regardless of which part of the filter membrane the substances reach. In portions other than the island-shape portions, the expansion parts having large volumes exist and thus, void portions are likely to exist and fluid flows in an opening direction via the void portions. Therefore, the substances larger than the opening parts are unlikely to block the opening parts, a filtration process can be more efficiently performed, and data with good reproducibility can be obtained.

Further, it is desirable that the filter membrane has a repeating structure in which, in a plan view of the filter membrane, a strip-shape portion, which has a predetermined width and forms a portion of the first surface, and an expansion part are repeated multiple times.

When the filter membrane has a repeating structure in which, in a plan view of the filter membrane, a strip-shape portion, which has a predetermined width and forms a portion of the first surface, and an expansion part are repeated multiple times, the filter membrane has excellent mechanical properties with respect to a direction perpendicular to a repetition direction of the repeating structure. By utilizing the above-described property to install the filter membrane on a filter device or the like while stretching the filter membrane in the direction perpendicular to the repetition direction of the repeating structure, the filter membrane can be suitably used as a filter without causing breakage or the like to the filter membrane.

Further, substances in a filtration processing fluid larger than the openings are in a state of being supported by the first surface formed by the strip-shape portions that each strip-shape portion has a predetermined width. In portions other than the first surface, the expansion parts exist and thus, void portions are likely to exist and fluid flows in an opening direction via the void portions. Therefore, the substances larger than the opening parts are unlikely to block the opening parts, a filtration process can be more efficiently performed, and data with good reproducibility can be obtained.

Each of the strip-shape portions does not necessarily have to have a linear shape such as a shape of an elongated rectangle, but may also have a curved shape as a whole such as a shape formed by drawing a curve, and may also have a bent portion in the middle.

In the filter membrane, in a plan view of the filter membrane, it is desirable that the first surface form a stripe pattern.

In the filter membrane, in a plan view of the filter membrane, when the first surface forms a stripe pattern in which a predetermined shape is repeated multiple times, the stripe pattern has excellent mechanical properties with respect to a direction perpendicular to a repetition direction. By utilizing the above-described property to install the filter membrane on a filter device or the like while stretching the filter membrane in the direction perpendicular to the repetition direction of the repeating structure, the filter membrane can be used as a filter without causing breakage or the like to the filter membrane.

Further, in a plan view of the filter membrane, when the first surface forms a stripe pattern, substances in a filtration processing fluid larger than the openings are in a state of being supported by the first surface of the stripe pattern. In portions other than the first surface, the expansion parts exist and thus, void portions are likely to exist and fluid flows in an opening direction via the void portions. Therefore, the substances larger than the opening parts are unlikely to block the opening parts, a filtration process can be more efficiently performed, and data with good reproducibility can be obtained.

In the filter membrane, it is desirable that the filter membrane be entirely formed of the same material and be integrally formed.

When the filter membrane is entirely formed of the same material and is integrally formed, the filter membrane can have more excellent mechanical properties without causing layer separation as in a case where two layers are adhered to each other, and variation in pore areas or pore diameters is unlikely to occur. Therefore, when the filter membrane is used for inspection, experiment or the like, data with good reproducibility can be obtained.

In the filter membrane, in a shape of a cross section that includes one of the openings and is perpendicular to the second surface, an angle formed by a wall surface of the expansion part continuing from the first surface and the first surface is desirably 43-80 degrees.

In the filter membrane, in the shape of the cross section that includes one of the openings and is perpendicular to the second surface, when the angle formed by the wall surface of the expansion part continuing from the first surface and the first surface is 43-80 degrees, of the expansion part continuing from the first surface, a cross-sectional area of a cross section parallel to the first surface becomes broader with decreasing distance from the first surface. Therefore, even when substances not to be filtered larger than the openings formed on the first surface approach the first surface, voids are likely to be formed between the openings and the substances not to be filtered, the opening parts are unlikely to be blocked, filtration can be continuously performed over a long time period, and a filtration process can be efficiently completed.

Further, an angle formed by the second surface and a wall surface of an opening part is also desirably 43-80 degrees. Since an inlet of the opening part is slightly larger than an outlet of the opening part, substances to be filtered having diameters equal to or less than a predetermined diameter are likely to easily pass through without causing clogging.

In the filter membrane, a diameter (r₁) of each of the opening parts is desirably 0.1-10.0 μm.

In the filter membrane, when the diameter (r₁) of each of the opening parts is 0.1-10.0 μm, extremely fine dust, viruses and the like can be removed from a gas or the like containing the dust, the viruses and the like. Further, fine components in a liquid such as those that form cells can also be selectively separated by filtration.

In the present specification, a diameter of an opening part means a diameter of the opening part at the second surface.

In the filter membrane, a relation between an interval (d) between the opening parts and the diameter (r₁) of each of the opening parts is desirably 0.2r₁≤d≤1.2r₁.

In the filter membrane, when the relation between the interval (d) between the opening parts and the diameter (r₁) of each of the opening parts is 0.2r₁≤d≤1.2r₁, the number of the opening parts per unit area is sufficiently large and mechanical strength can also be maintained, and a filter membrane having excellent durability is obtained. Filtration can be efficiently performed using the filter membrane.

In the present specification, the interval between the opening parts means an interval between the opening parts at the second surface.

In the filter membrane, a thickness (t₁) of a portion where only the opening parts are formed is desirably 1-4 μm and a thickness (t₂) of a portion where only the expansion parts are formed is desirably 3-16 μm.

In the filter membrane, when the thickness (t₁) of the portion where only the opening parts are formed is 1-4 μm and the thickness (t₂) of the portion where only the expansion parts are formed is 3-16 μm, filtration can be efficiently performed using a filter membrane having sufficient mechanical strength and excellent durability.

In the filter membrane, an aspect ratio (t₁/r₁) of each of the opening parts is desirably 8 or less.

In the filter membrane, when the aspect ratio (t₁/r₁) of each of the opening parts is 8 or less, each of the opening parts is not too thin and too long and thus, the filter membrane is unlikely to be clogged with substances to be filtered.

In the filter membrane, a ratio ((a₁/A)×100) of an area (a₁) where the opening parts are formed to a total area (A) of the filter membrane in a plan view is desirably 4-30%.

In the filter membrane, when the ratio of the area (a₁) where the opening parts are formed to the total area (A) of the filter membrane in a plan view is 4-30%, an area of the opening parts per unit area of the opening parts is sufficiently large and the mechanical strength can also be maintained, and filtration can be efficiently performed using a filter membrane excellent in durability.

In the present specification, the area where the opening parts are formed means the area of the opening parts at the second surface.

In the filter membrane, a ratio ((a₂/A)×100) of an area (a₂) where the expansion parts are formed to the total area (A) of the filter membrane in a plan view is desirably 20-80%.

In the filter membrane, when the ratio of the area (a₂) where the expansion parts are formed to the total area (A) of the filter membrane in a plan view is 20-80%, since the area of the expansion parts is sufficiently large, clogging or the like is unlikely to occur in the filter membrane and a filtration operation can be efficiently performed.

In the present specification, the area where the expansion parts are formed means the area of the expansion parts at the first surface.

Obviously, numerous modifications and variations of the present invention are possible in light of the above teachings. It is therefore to be understood that within the scope of the appended claims, the invention may be practiced otherwise than as specifically described herein.

1. A filter membrane, comprising:
a membrane comprising resin material and having a plurality of openings formed such that the plurality of openings selectively separates a specific material from other materials in a processing medium,
wherein the membrane has a first surface and a second surface on an opposite side with respect to the first surface such that the first surface is configured to receive the processing medium supplied to the membrane, the plurality of openings is formed through the membrane such that each of the openings has an opening part extending from the second surface toward the first surface and an expansion part expanding a size of the opening part and extending from the opening part to the first surface, and the first surface of the membrane is divided into a plurality of regions.

2. The filter membrane according to claim 1, wherein the membrane has a plurality of island-shape portions formed on the first surface such that the plurality of island-shape portions is interspersed between the expansion parts.

3. The filter membrane according to claim 2, wherein the island-shape portions is formed such that each of the island-shape portions has a quadrangular shape and that the island-shape portions are regularly positioned in vertical and horizontal directions.

4. The filter membrane according to claim 1, wherein the membrane has a repeating structure formed such that a plurality of strip-shape portions having a width is formed on the first surface and each of the strip-shape portions is extending between the expansion parts to form repetitions of the strip-shape portions and the expansion parts.

5. The filter membrane according to claim 4, wherein the membrane is formed such that the repeating structure forms a stripe pattern on the first surface.

6. The filter membrane according to claim 1, wherein the membrane is entirely formed of a same resin material integrally.

7. The filter membrane according to claim 1, wherein the membrane is formed such that each of the openings has an angle formed by the first surface and a wall surface of each of the expansion parts continuing from the first surface in a range of 43 degrees to 80 degrees.

8. The filter membrane according to claim 1, wherein the membrane is formed such that each of the opening parts has a diameter r₁ in a range of 0.1 μm to 10.0 μm.

9. The filter membrane according to claim 8, wherein the plurality of openings satisfies 0.2r₁≤d≤1.2r₁, where d is an interval between the opening parts and r₁ is the diameter r₁.

10. The filter membrane according to claim 1, wherein the membrane is formed such that a thickness t₁ of a portion where the opening parts are formed is in a range of 1 μm to 4 μm and that a thickness t₂ of a portion where the expansion parts are formed is in a range of 3 μm to 16 μm.

11. The filter membrane according to claim 8, wherein the membrane is formed such that an aspect ratio t₁/r₁ of each of the opening parts is 8 or less.

12. The filter membrane according to claim 1, wherein the membrane is formed such that a ratio ((a₁/A)×100) of an area a₁ where the opening parts are formed to a total area A of the membrane in a plan view is in a range of 4% to 30%.

13. The filter membrane according to claim 1, wherein the membrane is formed such that a ratio ((a₂/A)×100) of an area a₂ where the expansion parts are formed to a total area A of the membrane in a plan view is in a range of 20% to 80%.

14. The filter membrane according to claim 2, wherein the membrane has a repeating structure formed such that a plurality of strip-shape portions having a width is formed on the first surface and each of the strip-shape portions is extending between the expansion parts to from repetitions of the strip-shape portions and the expansion parts.

15. The filter membrane according to claim 14, wherein the membrane is formed such that the repeating structure forms a stripe pattern on the first surface.

16. The filter membrane according to claim 2, wherein the membrane is entirely formed of a same resin material integrally.

17. The filter membrane according to claim 2, wherein the membrane is formed such that each of the openings has an angle formed by the first surface and a wall surface of each of the expansion parts continuing from the first surface in a range of 43 degrees to 80 degrees.

18. The filter membrane according to claim 2, wherein the membrane is formed such that each of the openings has a diameter r₁ in a range of 0.1 μm to 10.0 μm.

19. The filter membrane according to claim 18, wherein the plurality of openings satisfies 0.2r₁≤d≤1.2r₁, where d is an interval between the opening parts and r₁ is the diameter r₁.

20. The filter membrane according to claim 2, wherein the membrane is formed such that a thickness t₁ of a portion where the opening parts are formed is in a range of 1 μm to 4 μm and that a thickness t₂ of a portion where the expansion parts are formed is in a range of 3 μm to 16 μm.
